(19) United States
(12) Patent Application Publication
(10) Pub. No.: US 2025/0309222 A1
(43) Pub. Date: Oct. 2, 2025

(54) COATING APPARATUS, METHOD OF MANUFACTURING POSITIVE ELECTRODE, AND METHOD OF MANUFACTURING SOLID-STATE BATTERY

(71) Applicant: HONDA MOTOR CO., LTD., Tokyo (JP)

(72) Inventors: Shuga IKEDA, Saitama (JP); Tsubasa HORIE, Saitama (JP); Shohei YOSHIDA, Saitama (JP); Satoshi YONEZAWA, Saitama (JP); Hiroshi SAKAI, Saitama (JP); Seiichi KOKETSU, Saitama (JP)

(21) Appl. No.: 19/004,468

(22) Filed: Dec. 30, 2024

(30) Foreign Application Priority Data
Mar. 29, 2024 (JP) 2024-056976

(51) Int. Cl. H01M 4/04

(52) U.S. Cl. CPC H01M 4/0411; H01M 4/0404

(57) ABSTRACT

Provided is a coating apparatus that includes: a conveyer configured to continuously convey a sheet-shaped material to be coated; a first die head configured to discontinuously form a first coating by intermittently discharging a first slurry toward a first surface region of the material to be coated that is conveyed continuously; a first storage configured to store the first slurry; a first supply channel for supplying the first slurry from the first storage to the first die head; and a first shutoff valve that is provided to the first supply channel and can shut off supply of the first slurry, the first supply channel having, in a range of motion by the first shutoff valve, a region having an inner diameter that is substantially the same as an outer diameter of the first shutoff valve.

This application is based on and claims the benefit of priority from Japanese Patent Application No. 2024-056976, filed on 29 Mar. 2024, the content of which is incorporated herein by reference.

### BACKGROUND OF THE INVENTION

### Field of the Invention

The present invention pertains to a coating apparatus, a method of manufacturing a positive electrode, and a method of manufacturing a solid-state battery.

### Related Art

In recent years, research and development pertaining to batteries that contribute to improving energy efficiency has been carried out in order to be able to ensure many people have access to sustainable, advanced energy that is affordable and reliable.

A battery is provided with: a positive electrode current collector; a positive electrode, which has a positive electrode mixture layer; a negative electrode current collector; a negative electrode, which has a negative electrode mixture layer; and an electrolyte. A coating apparatus is used when manufacturing the battery.

Patent Document 1 describes an intermittent-coating apparatus in which a liquid storage tank, a liquid feeding pump, and a liquid discharge die are connected in this order by liquid feeding pipes, and an intermittent supply valve is provided between the liquid feeding pump and the die. The intermittent supply valve is a two-way valve for supplying or stopping a coating liquid, is provided with a piston that has a valve body, a valve seat having a liquid passage that is shut by the valve body, and a movement means for causing the piston to move, the valve body being mounted to the piston in a manner that enables movement in an axial longitudinal direction.

Patent Document 1: Japanese Unexamined Patent Application, Publication No. 2001-38276

### SUMMARY OF THE INVENTION

However, when the coating liquid is intermittently discharged from the die in the coating apparatus described in Patent Document 1, dragging occurs at a trailing end of discharged coating liquid.

An object of the present invention is to provide a coating apparatus that is able to suppress dragging at a trailing end of discharged slurry, even if the slurry is intermittently discharged from a die head.
(1) A coating apparatus that includes: a conveyer configured to continuously convey a sheet-shaped material to be coated; a first die head configured to discontinuously form a first coating by intermittently discharging a first slurry toward a first surface region of the material to be coated that is conveyed continuously; a first storage configured to store the first slurry; a first supply channel for supplying the first slurry from the first storage to the first die head; and a first shutoff valve that is provided to the first supply channel and can shut off supply of the first slurry, the first supply channel having, in a range of motion by the first shutoff valve, a region having an inner diameter that is substantially the same as an outer diameter of the first shutoff valve.
(2) In the coating apparatus according to (1), the first shutoff valve has an incline formed on an outer peripheral portion of the first shutoff valve on a side close to the first storage, such that a thickness of the outer peripheral portion increases towards an outermost periphery of the first shutoff valve.
(3) In the coating apparatus according to (2), a recess is formed between the outer peripheral portion of the first shutoff valve on the side close to the first storage and a body of the first shutoff valve on the side close to the first storage.
(4) The coating apparatus according to any one of (1) through (3), further includes: a first solenoid valve; and a first slurry suctioner that is connected via the first solenoid valve to the first supply channel that is downstream of the first shutoff valve and is configured to suction the first slurry.
(5) The coating apparatus according to any one of (1) through (4) further includes: a second die head configured to discontinuously form a second coating by intermittently discharging a second slurry toward a second surface region of the material to be coated that is conveyed continuously; a second storage configured to store the second slurry; a second supply channel for supplying the second slurry from the second storage to the second die head; and a second shutoff valve that is provided to the second supply channel and can shut off supply of the second slurry, the second surface region being present downstream of the first surface region, and the second coating being formed in a region in which the first coating is not formed.
(6) The coating apparatus according to (5), the second supply channel having, in a range of motion by the second shutoff valve, a region having an inner diameter that is substantially the same as an outer diameter of the second shutoff valve.
(7) In the coating apparatus according to (5) or (6), the second shutoff valve has an incline formed on an outer peripheral portion of the second shutoff valve on a side close to the second storage, such that a thickness of the outer peripheral portion increases towards an outermost periphery of the second shutoff valve.
(8) The coating apparatus according to any one of (5) through (7) further includes: a second solenoid valve; and a second slurry suctioner that is connected via the second solenoid valve to the second supply channel that is downstream of the second shutoff valve and is configured to suction the second slurry.
(9) A method of manufacturing a positive electrode using the coating apparatus according to any one of (5) through (8), the material to be coated being a positive electrode current collector, the first slurry being a slurry for a positive electrode mixture layer, and the second slurry being a slurry for an insulating layer.
(10) A method of manufacturing a solid-state battery, the method including obtaining a positive electrode using the method of manufacturing a positive electrode according to (9).

By virtue of the present invention, it is possible to provide a coating apparatus that is able to suppress dragging at a trailing end of discharged slurry, even if the slurry is intermittently discharged from a die head.

### BRIEF DESCRIPTION OF THE DRAWINGS

FIG. 1 is a perspective view illustrating a coating apparatus according to one embodiment of the present invention;

FIG. 2 is a schematic view illustrating the coating apparatus in FIG. 1;

FIG. 3 is a top surface view for describing a first coating;

FIG. 4 is an enlarged cross-sectional view of a shutoff valve in FIG. 2;

FIG. 5 is a top surface view illustrating dragging at a trailing end of a first slurry;

FIG. 6 is a schematic view illustrating the coating apparatus in FIG. 1; and

FIG. 7 is a top surface view for describing a second coating.

### DETAILED DESCRIPTION OF THE INVENTION

With reference to the drawings, description is given below regarding an embodiment of the present invention.

### Coating Apparatus

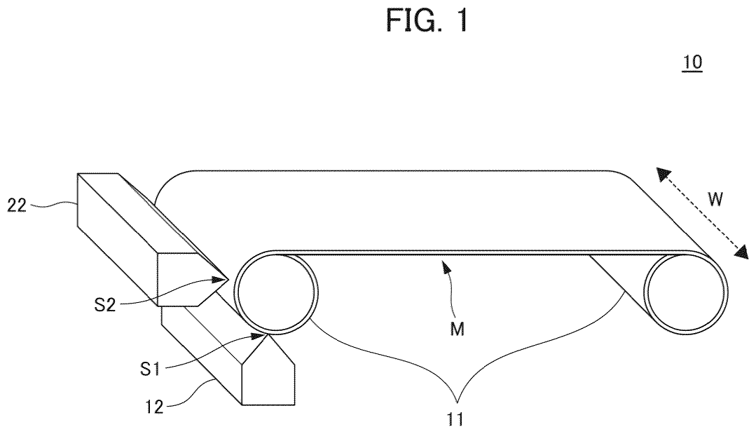

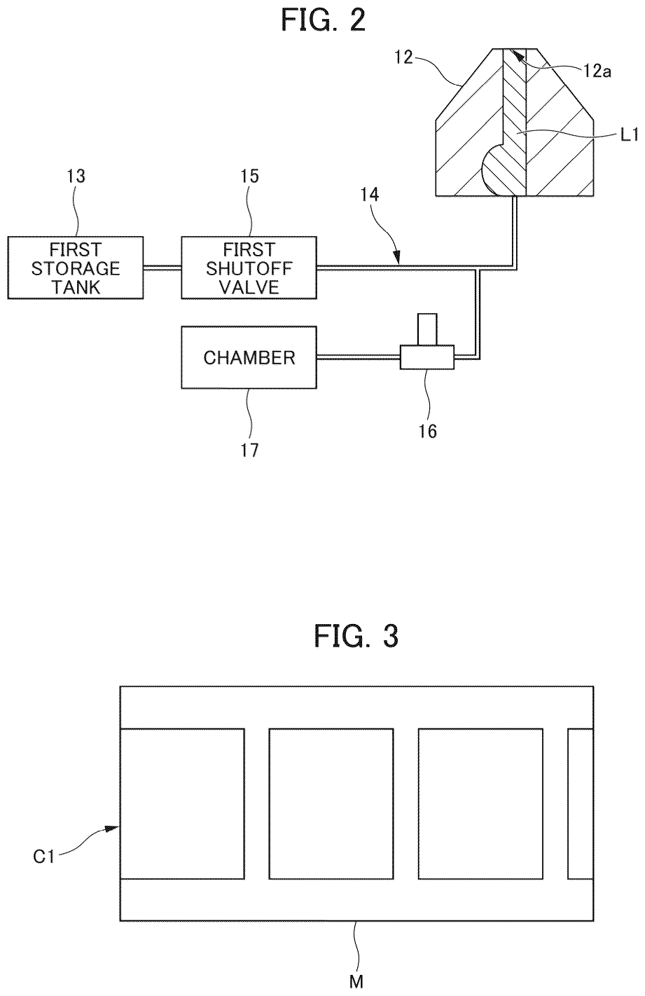

As illustrated in FIGS. 1 and 2, a coating apparatus 10 is provided with conveyance rollers 11 that serve as a conveyer for continuously conveying a sheet-shaped material to be coated M, and a first die head 12 for intermittently discharging a first slurry L1 toward a first surface region S1 of the material to be coated M that is continuously conveyed and thereby discontinuously forming a first coating C1 (refer to FIG. 3). Here, the first die head 12 has a slit-shaped first discharge port 12a, which extends in a width direction W of the material to be coated M and is for discharging the first slurry L1, and discharges the first slurry L1 in the first surface region S1 in a direction that is substantially orthogonal to the conveyance direction of the material to be coated M. In addition, the coating apparatus 10 is also provided with a first storage tank 13 that serves as a first storage for storing the first slurry L1, a first supply pipe 14 that serves as a first supply channel for supplying the first slurry L1 from the first storage tank 13 to the first die head 12, and a first shutoff valve 15 that is provided on the first supply pipe 14 and can shut off supply of the first slurry L1.

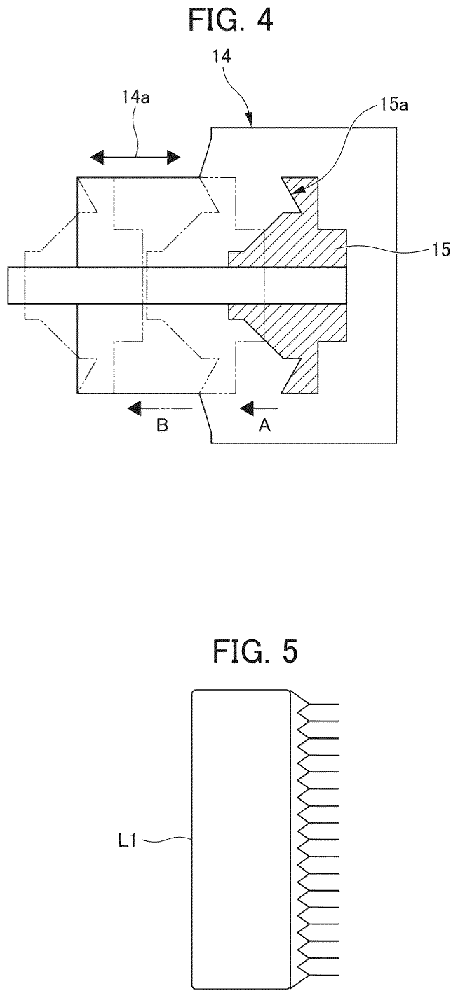

As illustrated in FIG. 4, the body of the first shutoff valve 15 on the side close to the first storage tank 13 is a truncated cone, and an incline 15a is formed on an outer peripheral portion of the first shutoff valve 15 on the side close to the first storage tank 13, such that the thickness of the outer peripheral portion increases towards the outermost periphery of the first shutoff valve 15. In other words, a recess is formed between the truncated cone body and the outer peripheral portion on which the incline 15a is formed. In addition, the first supply pipe 14 has a region 14a in which the inner diameter is substantially the same as the outer diameter of the first shutoff valve 15 in a range of motion by the first shutoff valve 15. Here, supply of the first slurry L1 is shut off in conjunction with a movement A by the first shutoff valve 15. In addition, the internal pressure of the first supply pipe 14 decreases in conjunction with a movement B by the first shutoff valve 15, and thus the first slurry L1 that was supplied to the first die head 12 is pulled back. Accordingly, dragging at a terminating end of the first slurry L1 that is discharged from the first die head 12 is suppressed. As a result, shape accuracy for the first coating C1 improves.

At this point, the angle of inclination of the incline 15a is not limited in particular, but is greater than 0° and less than or equal to 70°, for example. Note that the incline 15a does not need to be formed on an outer peripheral portion of the first shutoff valve 15. In other words, the first shutoff valve 15 may have a flat plate-shaped outer peripheral portion.

In addition, the coating speed for the first slurry L1 (conveyance speed of the material to be coated M) is not limited in particular, but is greater than or equal to 10 m/min and less than or equal to 60 m/min, for example. Furthermore, the viscosity at 25° C. of the first slurry L1 is not limited in particular, but is greater than or equal to 2000 mPa/s and less than or equal to 2500 mPa/s, for example.

Note that, when the region 14a, which has an inner diameter substantially the same as the outer diameter of the first shutoff valve 15, is not present in the first supply pipe 14 in the range of motion by the first shutoff valve 15, dragging occurs at a terminating end of the first slurry L1 discharged from the first die head 12 (refer to FIG. 5).

The first die head 12 is not limited in particular, and it is possible to use a publicly known die head as the first die head 12 if it is possible to discontinuously form the first coating C1 by intermittently discharging the first slurry L1.

As illustrated in FIG. 2, the coating apparatus 10 is also provided with a first solenoid valve 16 and a chamber 17 that serves as a first slurry suctioner for suctioning the first slurry L1, and is connected via the first solenoid valve 16 to the first supply pipe 14 on a downstream side with respect to the first shutoff valve 15. At this point, when the first solenoid valve 16 is opened at a timing when supply of the first slurry L1 is shut off, the first slurry L1 is suctioned, and thus the first slurry L1 supplied to the first die head 12 is further pulled back. In contrast, the first solenoid valve 16 is closed at a timing when supply of the first slurry L1 is started. Note that, the coating apparatus 10 may be used in a state where the first solenoid valve 16 is constantly closed.

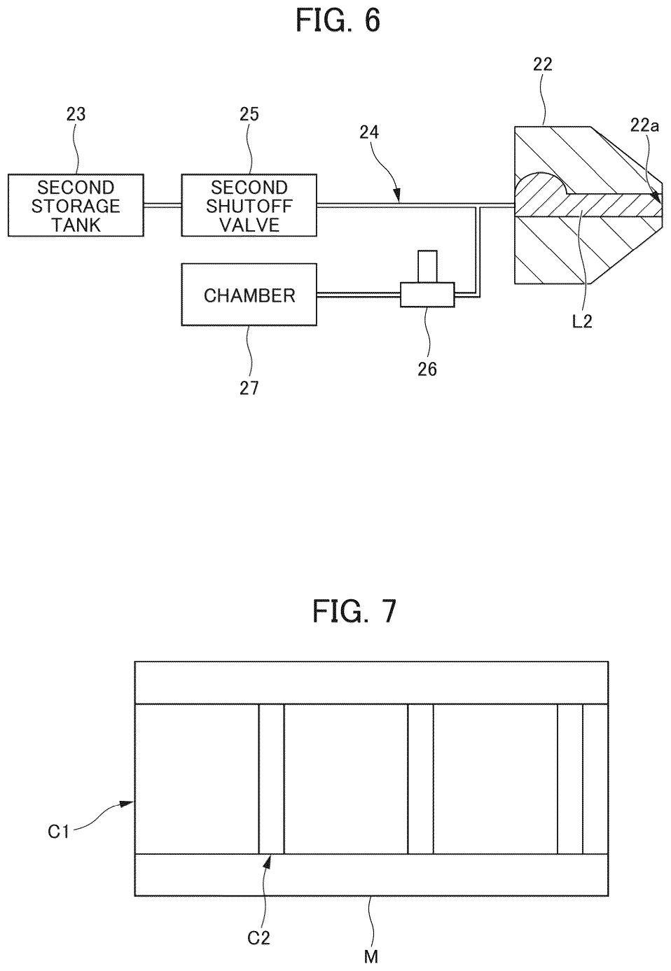

As illustrated in FIG. 6, the coating apparatus 10 is also provided with a second die head 22 that discontinuously forms a second coating C2 (refer to FIG. 7) by intermittently discharging a second slurry L2 toward a second surface region S2 of the material to be coated M that is continuously conveyed. Here, the second die head 22 has a slit-shaped second discharge port 22a, which extends in the width direction W of the material to be coated M and is for discharging the second slurry L2, and discharges the second slurry L2 in the second surface region S2 in a direction that is substantially orthogonal to the conveyance direction of the material to be coated M. At this point, the second surface region S2 is present downstream of the first surface region S1, and the second coating C2 is formed in a region in which the first coating C1 has not been formed. As a result, the shape accuracy of the second coating C2 also improves in conjunction with the high shape accuracy for the first coating C1. In addition, the coating apparatus 10 is also provided with a second storage tank 23 that serves as a second storage for storing the second slurry L2, a second supply pipe 24 that serves as a second supply channel for supplying the second slurry L2 from the second storage tank 23 to the second die head 22, and a second shutoff valve 25 that is provided on the second supply pipe 24 and can shut off supply of the second slurry L2.

Similarly to the first shutoff valve 15 (refer to FIG. 4), the body of the second shutoff valve 25 on the side close to the second storage tank 23 is a truncated cone, and an incline is formed on an outer peripheral portion of the second shutoff valve 25 on the side close to the second storage tank 23, such that the thickness of the outer peripheral portion increases towards the outermost periphery of the second shutoff valve 25. In other words, a recess is formed between the truncated cone body and the outer peripheral portion on which the incline is formed. In addition, similarly to the first supply pipe 14 (refer to FIG. 4), the second supply pipe 24 has a region in which the inner diameter is substantially the same as the outer diameter of the second shutoff valve 25 in a range of motion by the second shutoff valve 25. Here, after supply of the second slurry L2 is shut off in conjunction with movement by the second shutoff valve 25, the internal pressure in the second supply pipe 24 decreases in conjunction with the movement by the second shutoff valve 25, and thus the second slurry L2 that was supplied to the second die head 22 is pulled back. Accordingly, dragging at a terminating end of the second slurry L2 that is discharged from the second die head 22 is suppressed. As a result, shape accuracy for the second coating C2 improves.

In addition, the coating speed for the second slurry L2 (conveyance speed of the material to be coated M) is not limited in particular, but is greater than or equal to 10 m/min and less than or equal to 60 m/min, for example. Furthermore, the viscosity at 25° C. of the second slurry L2 is not limited in particular, but is greater than or equal to 2000 mPa/s and less than or equal to 2500 mPa/s, for example.

The second die head 22 is not limited in particular, and it is possible to use a publicly known die head as the second die head 22 if it is possible to discontinuously form the second coating C2 by intermittently discharging the second slurry L2.

The coating apparatus 10 is also provided with a second solenoid valve 26 and a chamber 27 that serves as a second slurry suctioner for suctioning the second slurry, and is connected via the second solenoid valve 26 to the second supply pipe 24 on a downstream side with respect to the second shutoff valve 25. At this point, when the second solenoid valve 26 is opened at a timing when supply of the second slurry L2 is shut off, the second slurry L2 is suctioned, and thus the second slurry L2 supplied to the second die head 22 is further pulled back. In contrast, the second solenoid valve 26 is closed at a timing when supply of the second slurry L2 is started. Note that, the coating apparatus 10 may be used in a state where the second solenoid valve 26 is constantly closed.

Note that, if necessary, the second supply pipe 24 does not need to have a region in which the inner diameter is substantially the same as the outer diameter of the second shutoff valve 25 in a range of motion by the second shutoff valve 25. In addition, an incline does not need to be formed on an outer peripheral portion of the second shutoff valve 25, and it may be that second die head 22, the second storage tank 23, the second supply pipe 24, and the second shutoff valve 25 are omitted.

In addition, the coating apparatus 10 does not need to be provided with the second die head 22, the second storage tank 23, the second supply pipe 24, the second shutoff valve 25, the second solenoid valve 26, and the chamber 27. In other words, the coating apparatus 10 may be an apparatus that coats only the first slurry L1.

### Coating Method

The coating method according to the present embodiment includes a step for, while continuously conveying the sheet-shaped material to be coated M, using the coating apparatus 10 to discontinuously form the first coating C1 by intermittently discharging the first slurry L1 from the first die head 12 toward the first surface region S1 of the material to be coated M that is continuously conveyed.

The coating method according to the present embodiment may further include a step for, while continuously conveying the material to be coated M, using the coating apparatus 10 to discontinuously form the second coating C2 by intermittently discharging the second slurry L2 from the second die head 22 toward the second surface region S2.

The coating method according to the present embodiment may further include a step for heating and drying the material to be coated M on which the first coating C1 (and the second coating C2) has been formed.

Note that the coating method according to the present embodiment can be applied to, for example, manufacture of a positive electrode, a negative electrode and a solid electrolyte layer, which are included in a battery.

### Method of Manufacturing Positive Electrode

A method of manufacturing a positive electrode according to the present embodiment uses the coating method according to the present embodiment to manufacture a positive electrode. Here, the material to be coated M is a positive electrode current collector, the first slurry is a slurry for a positive electrode mixture layer, and the second slurry is a slurry for an insulating layer. Accordingly, a positive electrode having a high shape accuracy for the positive electrode mixture layer and the insulating layer is achieved.

The positive electrode current collector is not limited in particular, but may be aluminum foil, for example.

The slurry for a positive electrode mixture layer includes a positive electrode active material, for example. The positive electrode active material is not limited in particular, but may be lithium iron phosphate, for example.

The slurry for an insulating layer includes an insulating material. The insulating material is not limited in particular, but may be alumina, for example.

The method of manufacturing a positive electrode according to the present embodiment may further include a step for continuously forming a second insulating layer on both sides of the positive electrode mixture layer in the width direction W. At this point, the second insulating layer may be formed when forming the positive electrode mixture layer.

### Method of Manufacturing Solid-State Battery

A method of manufacturing a solid-state battery according to the present embodiment includes a step for using the method of manufacturing a positive electrode according to the present embodiment to achieve a positive electrode. Accordingly, short-circuiting of a solid-state battery is suppressed.

The method of manufacturing a solid-state battery according to the present embodiment may further include a step for forming a stack of a positive electrode and a solid electrolyte layer by forming a solid electrolyte layer on the positive electrode mixture layer.

The solid-state battery is not limited in particular, but may be an all-solid-state lithium metal battery, for example. Description is given below regarding an all-solid-state lithium metal battery.

An all-solid-state lithium metal battery is provided with: a negative electrode current collector; a negative electrode, which has a lithium metal layer; a positive electrode current collector; a positive electrode, which has a positive electrode mixture layer; and a solid electrolyte layer.

The negative electrode current collector is not limited in particular, but may be copper foil, for example.

The positive electrode mixture layer includes a positive electrode active material, and may further include a solid electrolyte, an electrically conductive aid, a binder, or the like. The positive electrode active material is not limited in particular if the positive electrode active material is able to occlude and discharge lithium ions, but may be a lithium nickel cobalt manganese composite oxide, for example. The solid electrolyte is not limited in particular if the solid electrolyte has lithium-ion conductivity, but may be an oxide electrolyte or a sulfide electrolyte, for example. The electrically conductive aid is not limited in particular if the electrically conductive aid has electron conductivity, but may be carbon black, for example. The binder is not limited in particular if the binder can improve binding ability, but may be styrene-butadiene rubber, for example.

The positive electrode current collector is not limited in particular, but may be aluminum foil, for example.

The solid electrolyte layer includes a solid electrolyte, and may further include a binder or the like. The solid electrolyte is not limited in particular if the solid electrolyte has lithium-ion conductivity, but may be an inorganic solid electrolyte such as an oxide electrolyte or a sulfide electrolyte, for example. The binder is not limited in particular if the binder can improve binding ability, but may be styrene-butadiene rubber, for example.

Note that an intermediate layer, which has a function of uniformly depositing lithium metal, may be formed between the negative electrode and the solid electrolyte layer. As a result, the interface between the intermediate layer and the solid electrolyte layer is stabilized. In this case, the all-solid-state lithium metal battery may be an anode-free battery in which a lithium metal layer has not been formed at a time of initial charging. A lithium metal layer is formed in the anode-free battery after initial charging and discharging.

The intermediate layer includes amorphous carbon and a metal that can form an alloy with lithium, and may further include a binder or the like. It is desirable for the amorphous carbon and the metal that can form an alloy with lithium to be nanoparticles. The metal that can form an alloy with lithium may be, for example, tin (Sn), silicon (Si), zinc (Zn), magnesium (Mg), gold (Au), platinum (Pt), palladium (Pd), silver (Ag), aluminum (Al), bismuth (Bi), or antimony (Sb). The amorphous carbon may be, for example, activated carbon, coke, or a carbon black such as acetylene black, furnace black, or Ketjen black. The amorphous carbon may be carbon that is easy to graphitize (soft carbon), or may be carbon that is difficult to graphitize (hard carbon), carbon nanotubes (CNT), fullerene, or graphene. The binder is not limited in particular if the binder can improve binding ability, but may be polyvinylidene fluoride (PVDF), for example.

Description is given above regarding an embodiment of the present invention, but the present invention is not limited to the embodiment described above, and the above-described embodiment may be modified, as appropriate, within the range of the spirit of the present invention.

### EXAMPLES

An example of the present invention is described below, but the present invention is not limited to this example.

### Example 1

Using the coating apparatus 10 (refer to FIG. 1), a positive electrode mixture layer was discontinuously formed onto a positive electrode current collector. Specifically, while continuously conveying an aluminum foil (positive electrode current collector) that corresponds to the material to be coated M, a positive electrode mixture layer, which corresponds to the first coating C1, was discontinuously formed by intermittently discharging a slurry for a positive electrode mixture layer that corresponds to the first slurry L1 from the first die head 12 (refer to FIG. 2) toward the first surface region S1 of the material to be coated M that is continuously conveyed. At this point, the coating apparatus 10 was used in a state where the first solenoid valve 16 is constantly closed. The angle of inclination of the incline 15a formed on the outer peripheral portion of the first shutoff valve 15 was set to 64°. In addition, a slurry including lithium iron phosphate, which corresponds to a positive electrode active material, and having a viscosity at 25° C. of greater than or equal to 2000 mPa/s and less than or equal to 2500 mPa/s was used as the slurry for a positive electrode mixture layer, and the coating speed (conveyance speed of the material to be coated M) of the first slurry L1 was set to 60 m/min.

### Comparative Example 1

Apart from setting the inner diameter of the region 14a of the first supply pipe 14 to be smaller than the outer diameter of the first shutoff valve 15—in other words, not setting the region 14a of the first supply pipe 14 to be the range of motion by the first shutoff valve 15, a positive electrode mixture layer was discontinuously formed on a positive electrode current collector, similarly to in Example 1.

### Dragging

Dragging at a trailing end of discharged first slurry L1 was measured.

Table 1 indicates a result of evaluating dragging.

TABLE 1

| | | Comparative |
|---|---|---|
| | Example 1 | Example 1 |
| Dragging [mm] | 6 | 8 |

From Table 1, it is understood that dragging at the trailing end of discharged first slurry L1 is suppressed in Example 1.

### EXPLANATION OF REFERENCE NUMERALS

10 Coating apparatus
11 Conveyance roller
12 First die head
12a First discharge port
13 First storage tank
14 First supply pipe
14a Region
15 First shutoff valve
15a Incline
16 First solenoid valve
17 Chamber
22 Second die head
22a Second discharge port
23 Second storage tank
24 Second supply pipe
25 Second shutoff valve
26 Second solenoid valve
27 Chamber
C1 First coating
C2 Second coating
L1 First slurry
L2 Second slurry
M Material to be coated
S1 First surface region
S2 Second surface region
W Width direction

What is claimed is:

1. A coating apparatus, comprising:
a conveyer configured to continuously convey a sheet-shaped material to be coated;
a first die head configured to discontinuously form a first coating by intermittently discharging a first slurry toward a first surface region of the material to be coated that is conveyed continuously;
a first storage configured to store the first slurry;
a first supply channel for supplying the first slurry from the first storage to the first die head; and
a first shutoff valve that is provided to the first supply channel and can shut off supply of the first slurry,
wherein the first supply channel has, in a range of motion by the first shutoff valve, a region having an inner diameter that is substantially the same as an outer diameter of the first shutoff valve.

2. The coating apparatus according to claim 1, wherein
the first shutoff valve has an incline formed on an outer peripheral portion of the first shutoff valve on a side close to the first storage, such that a thickness of the outer peripheral portion increases towards an outermost periphery of the first shutoff valve.

3. The coating apparatus according to claim 2, wherein
a recess is formed between the outer peripheral portion of the first shutoff valve on the side close to the first storage and a body of the first shutoff valve on the side close to the first storage.

4. The coating apparatus according to claim 1, further comprising:
a first solenoid valve; and
a first slurry suctioner that is connected via the first solenoid valve to the first supply channel that is downstream of the first shutoff valve and is configured to suction the first slurry.

5. The coating apparatus according to claim 1, further comprising:
a second die head configured to discontinuously form a second coating by intermittently discharging a second slurry toward a second surface region of the material to be coated that is conveyed continuously;
a second storage configured to store the second slurry;
a second supply channel for supplying the second slurry from the second storage to the second die head; and
a second shutoff valve that is provided to the second supply channel and can shut off supply of the second slurry,
wherein the second surface region is present downstream of the first surface region, and
the second coating is formed in a region in which the first coating is not formed.

6. The coating apparatus according to claim 5, wherein
the second supply channel has, in a range of motion by the second shutoff valve, a region having an inner diameter that is substantially the same as an outer diameter of the second shutoff valve.

7. The coating apparatus according to claim 5, wherein
the second shutoff valve has an incline formed on an outer peripheral portion of the second shutoff valve on a side close to the second storage, such that a thickness of the outer peripheral portion increases towards an outermost periphery of the second shutoff valve.

8. The coating apparatus according to claim 5, further comprising:
a second solenoid valve; and
a second slurry suctioner that is connected via the second solenoid valve to the second supply channel that is downstream of the second shutoff valve and is configured to suction the second slurry.

9. A method of manufacturing a positive electrode using the coating apparatus according to claim 5, wherein
the material to be coated is a positive electrode current collector,
the first slurry is a slurry for a positive electrode mixture layer, and
the second slurry is a slurry for an insulating layer.

10. A method of manufacturing a solid-state battery, the method comprising obtaining a positive electrode using the method of manufacturing a positive electrode according to claim 9.
